(19) United States
(12) Patent Application Publication
(10) Pub. No.: US 2016/0352449 A1
(43) Pub. Date: Dec. 1, 2016

(54) OPTICAL TRANSMISSION DEVICE THAT TRANSMITS WAVELENGTH DIVISION MULTIPLEXED OPTICAL SIGNAL

(71) Applicant: FUJITSU LIMITED, Kawasaki-shi (JP)

(72) Inventor: TOSHIKI HONDA, Kawasaki (JP)

(73) Assignee: FUJITSU LIMITED, Kawasaki-shi (JP)

(21) Appl. No.: 15/064,770

(22) Filed: Mar. 9, 2016

(30) Foreign Application Priority Data
May 25, 2015 (JP) 2015-105433

(51) Int. Cl. H04J 14/02; H04B 10/564; H04B 10/079

(52) U.S. Cl. CPC H04J 14/0221; H04B 10/07955; H04B 10/564

(57) ABSTRACT

An optical transmission device includes: a monitor configured to monitor a power of an input optical signal and detect a spectrum of the input optical signal; a detector configured to detect a wavelength division multiplexed optical signal that includes a plurality of carriers continuously allocated at a specified frequency spacing based on the spectrum of the input optical signal; a generator configured to generate adjustment information that specifies an attenuation amount in a frequency range in which the wavelength division multiplexed optical signal is allocated; and a power adjustment device configured to adjust powers of respective carriers multiplexed in the wavelength division multiplexed optical signal according to the adjustment information generated by the generator.

### CROSS-REFERENCE TO RELATED APPLICATION

This application is based upon and claims the benefit of priority of the prior Japanese Patent Application No. 2015-105433, filed on May 25, 2015, the entire contents of which are incorporated herein by reference.

### FIELD

The embodiments discussed herein are related to an optical transmission device that transmits a wavelength division multiplexed (WDM) optical signal.

### BACKGROUND

In recent years, a WDM transmission system that uses wavelength division multiplexing (WDM) has become widespread. WDM can multiplex a plurality of optical signals of different wavelengths to transmit the multiplexed optical signals. In the WDM transmission system, each node includes an optical add-drop multiplexer (ROADM: Reconfigurable Optical Add Drop Multiplexer). The ROADM is able to drop an optical signal of a desired wavelength from a WDM optical signal, and is able to add an optical signal to an empty channel of a WDM optical signal.

Further, with the proliferation of high-speed mobile communications and cloud services that use an Internet connection, communications traffic has been increasing rapidly. Thus, a technology for increasing a transmission capacity of a WDM transmission system has been investigated. For example, as one of the technologies that increase a transmission rate of each wavelength channel, a digital coherent detection has been put to practical use. Further, a technology for increasing the number of wavelength channels multiplexed in a WDM optical signal by narrowing a wavelength spacing of WDM has been investigated. For example, a superchannel is able to multiplex a plurality of carriers continuously allocated at a frequency spacing not greater than 50 GHz, so as to provide a desired transmission capacity.

As a related technology, an optical power monitor that is able to monitor an optical power of an optical signal correctly even when the wavelength spacing of the optical signal is small has been proposed (see, for example, Japanese Laid-open Patent Publication No. 2013-201495). Further, a wavelength division multiplexing optical transmission device that realizes the optimization of the transmission characteristics by simultaneously controlling optical transmission powers of a target wavelength and its adjacent wavelength has been proposed (see, for example, Japanese Laid-open Patent Publication No. 2012-105167). Furthermore, a method for decreasing a crossconnect between sub-carriers of a superchannel has been proposed (see, for example, Japanese Laid-open Patent Publication No. 2014-217054).

The transmission characteristics of a WDM optical signal may be deteriorated due to a crosstalk between adjacent wavelength channels. Especially, the crosstalk between adjacent wavelength channels increases when a wavelength spacing of WDM is smaller (for example, when a superchannel is implemented), which results in a degradation in the quality of each wavelength channel. In this case, when the allocation of carriers that implement the superchannel is known, the problem due to a crosstalk may be mitigated by appropriately controlling an optical power of each carrier according to the allocation.

However, in recent years, a network in which a capacity and/or a route of an optical path can be flexibly changed according to a user's request has been proposed. In such a network, the allocation of carriers that implement a superchannel may change frequently. In other words, in order to suppress a crosstalk between adjacent wavelength channels, it is necessary to control an optical power of each carrier every time a capacity and/or a route of an optical path changes.

On the other hand, a configuration in which an SDN (Software Defined Network) technology is used for controlling a network device has been discussed. For example, the SDN is able to realize a flow control by use of a common language such as OpenFlow. Further, a WDM transmission device is anticipated to also be controlled by the SDN in the future. However, a control of a superchannel (for example, settings of a superchannel and a change in the capacity of a superchannel) is designed uniquely for each vendor. Thus, even when the SDN is widespread, a flow message will be complicated if a superchannel is controlled by use of a common language such as OpenFlow. As a result, preferably, a WDM transmission device is able to suppress a crosstalk between wavelength channels of a WDM optical signal (especially, of a superchannel signal) without being controlled from the outside (for example, a flow message by the SDN).

### SUMMARY

According to an aspect of the invention, an optical transmission device includes: a monitor configured to monitor a power of an input optical signal and detect a spectrum of the input optical signal; a detector configured to detect a wavelength division multiplexed optical signal that includes a plurality of carriers continuously allocated at a specified frequency spacing based on the spectrum of the input optical signal; a generator configured to generate adjustment information that specifies an attenuation amount in a frequency range in which the wavelength division multiplexed optical signal is allocated; and a power adjustment device configured to adjust powers of respective carriers multiplexed in the wavelength division multiplexed optical signal according to the adjustment information generated by the generator.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical network;

FIG. 2 illustrates an example of a WDM transmission device;

FIG. 3 illustrates another example of a WDM transmission device;

FIG. 4 illustrates a transmitter in still another example of a WDM transmission device;

FIG. 5 illustrates a receiver in the still another example of a WDM transmission device;

FIGS. 6A and 6B illustrate an interaction between carriers multiplexed in a superchannel;

FIG. 7 illustrates optimization of a superchannel signal;

FIGS. 8A and 8B illustrate effects of optimization of a superchannel signal;

FIG. 9 illustrates an example of an optical transmission device according to a first embodiment;

FIG. 10 illustrates an example of optical signals generated by a plurality of line cards;

FIG. 11 illustrates an example of an optimization database according the first embodiment;

FIG. 12 schematically illustrates an attenuation function of a wavelength selective switch;

FIGS. 13A-13C are diagrams for explaining methods for detecting a superchannel signal by use of an output of an optical channel monitor;

FIG. 14 illustrates an example of a management table according to the first embodiment;

FIG. 15 illustrates another example of a management table according to the first embodiment;

FIG. 16 is a flowchart that illustrates an example of processing of optimizing a superchannel signal;

FIG. 17 illustrates an example of an optical transmission device according to a second embodiment;

FIG. 18 illustrates an example of an optimization database according the second embodiment; and

FIG. 19 illustrates an example of a management table according to the second embodiment.

### DESCRIPTION OF EMBODIMENTS

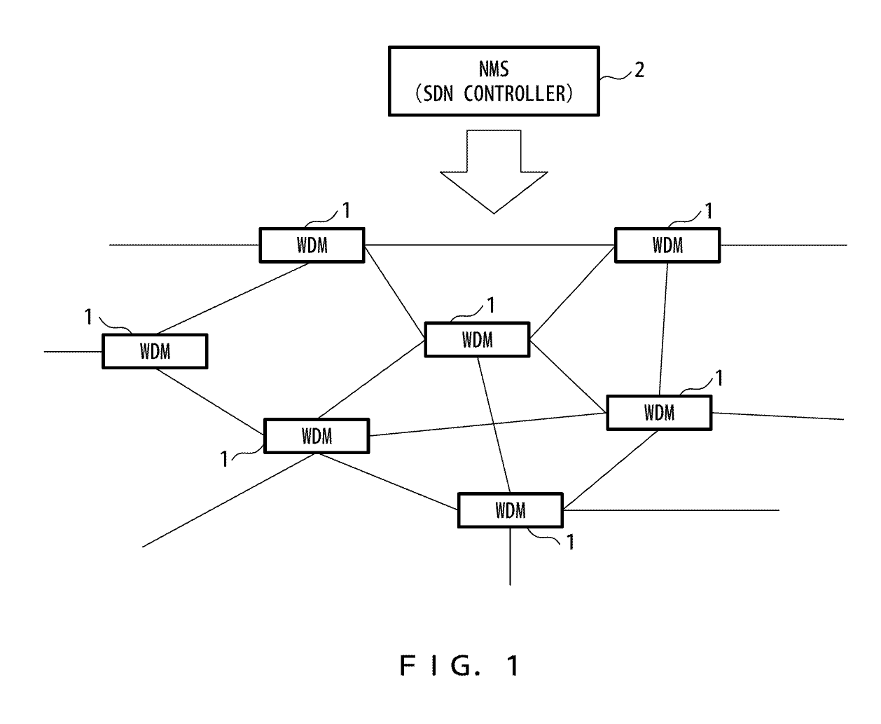

FIG. 1 illustrates an example of an optical network in which an optical transmission device according to embodiments of the present invention. The optical network illustrated in FIG. 1 transmits a WDM optical signal. In other words, the optical transmission device according to the embodiments of the present invention is a WDM transmission device. Each node in the optical network includes a WDM transmission device 1. In this example, a plurality of WDM transmission devices 1 are mesh-connected to one another.

A network management system (NMS) 2 monitors a state of each WDM transmission device 1, and is able to change the settings of each WDM transmission device 1. For example, the network management system 2 can establish an optical path of a specified bandwidth between specified nodes. The optical network may be configured to include an SND controller instead of the network management system 2.

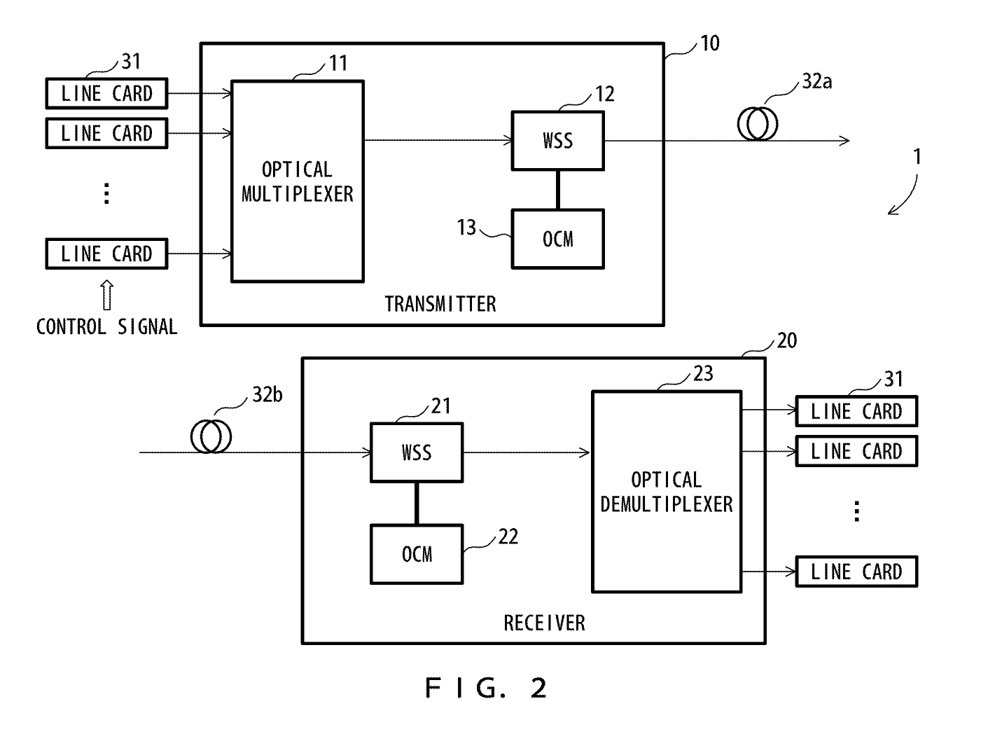

FIG. 2 illustrates an example of a WDM transmission device. In this example, the WDM transmission device 1 includes a transmitter 10 and a receiver 20. Note that the WDM transmission device 1 may include other circuit elements that are not illustrated in FIG. 2.

The WDM transmission device 1 can accommodate a plurality of line cards 31. A line card 31 is, for example, an optical transceiver circuitry that includes a transmitter circuit and a receiver circuit. In this case, a transmitter circuit in the line card 31 includes an LD light source and an optical modulator and outputs a modulated optical signal that carries data. A receiver circuit in the line card 31 includes an optical receiver and an optical demodulator and demodulates a received modulated optical signal so as to recover data.

The transmitter 10 includes an optical multiplexer 11, a wavelength selective switch (WSS) 12, and an optical channel monitor (OCM) 13. The optical multiplexer 11 combines a plurality of optical signals output from the plurality of line cards 31 so as to generate a WDM optical signal. The wavelength selective switch 12 processes respective wavelength channels multiplexed in the WDM optical signal. For example, when an instruction to stop an optical signal of a certain wavelength channel is issued, the wavelength selective switch 12 blocks the optical signal of the wavelength channel by adequately attenuating an optical power of the wavelength channel. The optical channel monitor 13 detects optical powers of respective wavelength channels multiplexed in the WDM optical signal. In other words, the optical channel monitor 13 monitors a state of an input WDM optical signal. Then, the transmitter 10 outputs, to an optical transmission path 32a, the WDM optical signal including an optical signal that has passed through the wavelength selective switch 12.

The receiver 20 includes a wavelength selective switch 21, an optical channel monitor 22, and an optical demultiplexer 23. The wavelength selective switch 21 processes respective wavelength channels multiplexed in a WDM optical signal received through an optical transmission path 32b. The optical channel monitor 22 detects optical powers of respective wavelength channels multiplexed in the received WDM optical signal. The optical demultiplexer 23 separates the received WDM optical signal for each wavelength channel and guides each optical signal to a corresponding line card 31.

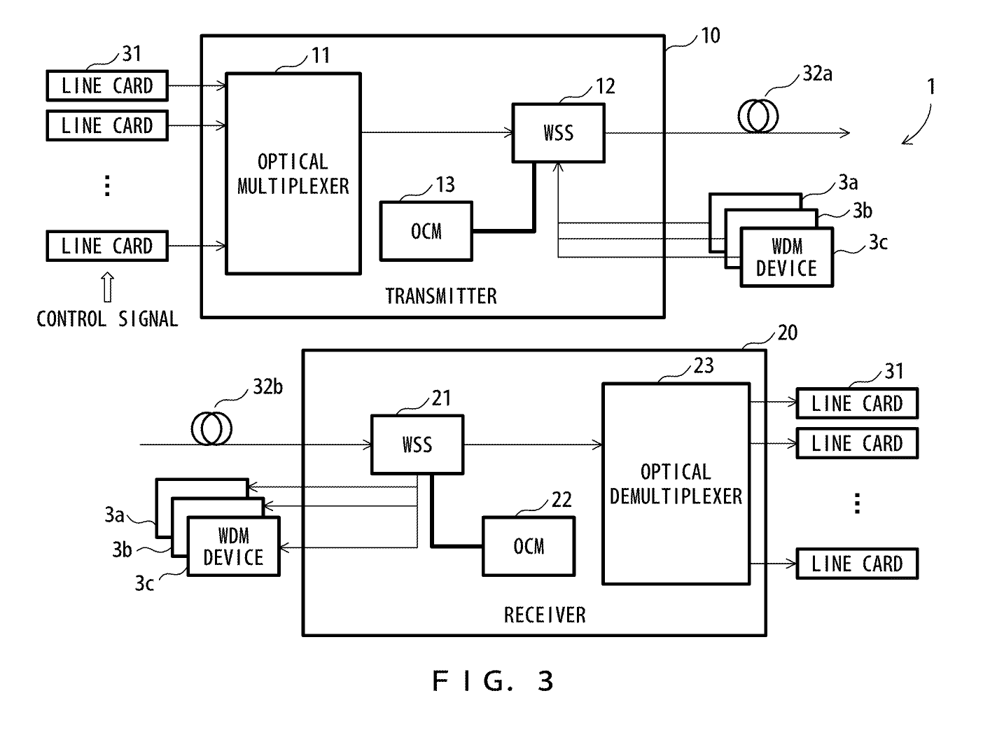

FIG. 3 illustrates another example of a WDM transmission device. A plurality of WDM transmission devices 3a-3c are connected to a WDM transmission device 1 of FIG. 3. The WDM transmission device 1 and the WDM transmission devices 3a-3c may be provided in the same location or, they may be provided in different locations. WDM optical signals that are guided from the WDM transmission devices 3a-3c to the WDM transmission device 1 are processed by the wavelength selective switch 12 of the transmitter 10. The WDM optical signal received through the optical transmission path 32b is processed by the wavelength selective switch 21 of the receiver 20 and is guided to the optical demultiplexer 23 and to the WDM transmission devices 3a-3c.

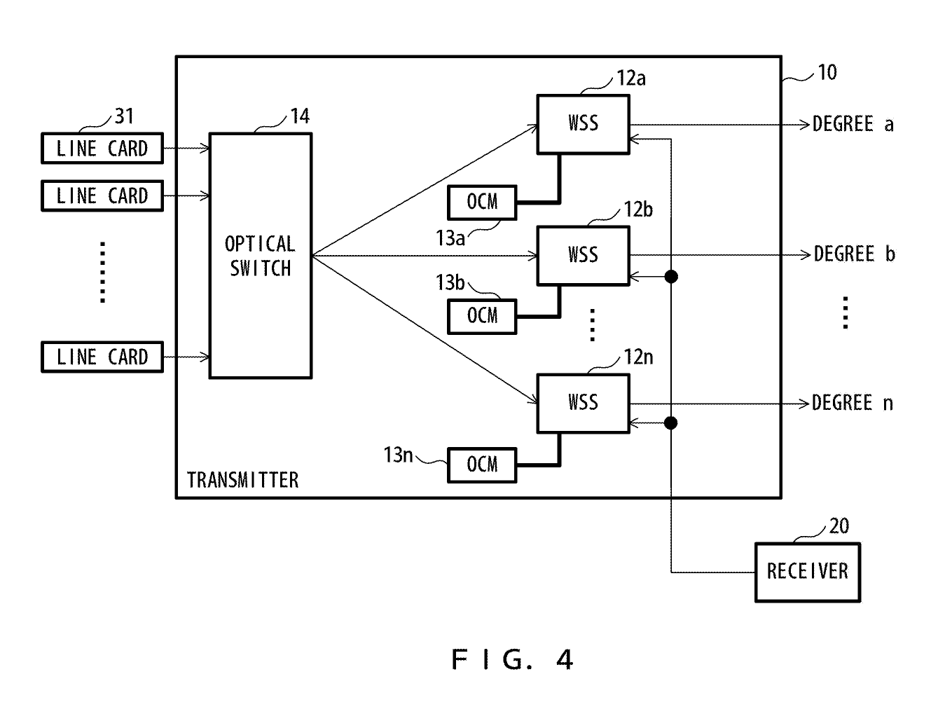

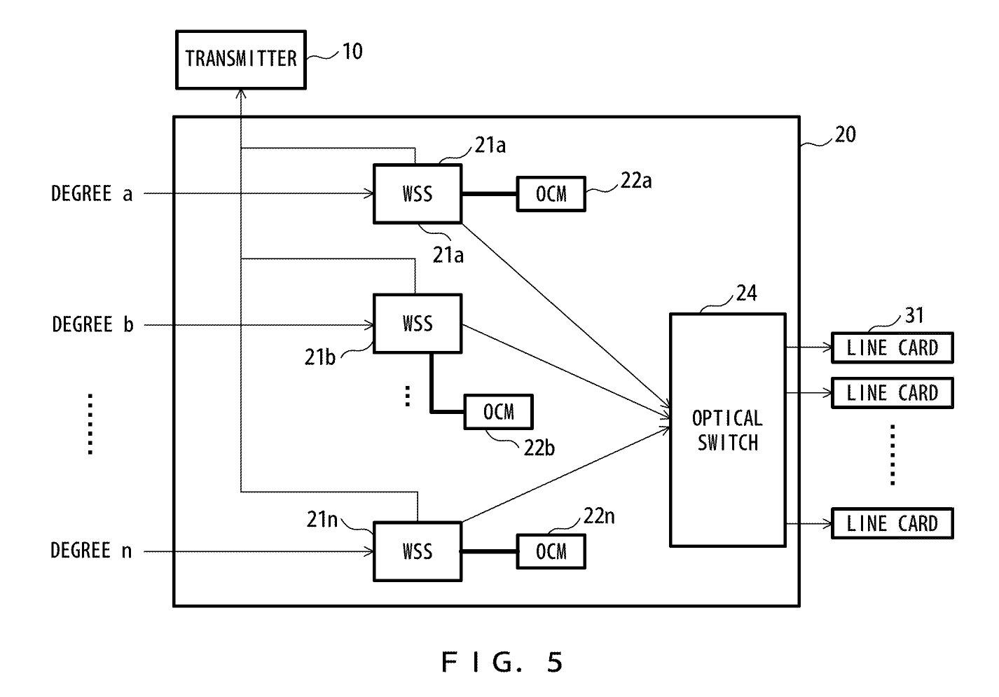

FIGS. 4 and 5 illustrate still another example of a WDM transmission device. The WDM transmission device illustrated in FIGS. 4 and 5 implements a CDC (Color-less, Direction-less, Contention-less)-ROADM. In this case, as illustrated in FIG. 4, the transmitter 10 includes an optical switch 14, wavelength selective switches 12a-12n, and optical channel monitors 13a-13n. The wavelength selective switches 12a-12n and the optical channel monitors 13a-13n are provided with respect to corresponding degrees. The optical switch 14 guides an optical signal generated by a line card 31 to a wavelength selective switch corresponding to a degree to which the optical signal is to be output. As illustrated in FIG. 5, the receiver 20 includes wavelength selective switches 21a-21n, optical channel monitors 22a-22n, and an optical switch 24. The wavelength selective switches 21a-21n and the optical channel monitors 22a-22n are provided with respect to corresponding degrees. The optical switch 24 guides an optical signal received from each of the degrees a-n to a corresponding line card 31.

The WDM transmission device of the embodiments can transmit a superchannel signal. The superchannel signal is one of the forms of a DWDM (Dense WDM) optical signal. However, a superchannel can transmit an integrated signal with a desired capacity using a plurality of adjacent wavelength channels (or a plurality of adjacent carriers). In this case, the number of carriers multiplexed in a superchannel signal is determined according to a transmission capacity requested by a user. The carrier that is multiplexed in the superchannel may be referred to as a “subcarrier”.

The configuration of a superchannel is determined, for example, according to a request from a user. In this case, a control signal that issues an instruction on the configuration of a superchannel is provided to a corresponding node (for example, a source node and a destination node of a superchannel signal). For example, this control signal specifies the number of carriers multiplexed in a superchannel signal and a frequency (or a wavelength) of each of the carriers multiplexed in the superchannel signal. As a result, in a source node, a superchannel signal is generated by a required number of line cards 31 according to the control signal.

As described above, a superchannel signal is implemented by use of a plurality of adjacent carriers. In this case, for example, the superchannel signal is implemented by use of a plurality of carriers continuously allocated at a spacing not greater than 50 GHz. As an example, the superchannel signal is implemented by use of a plurality of carriers continuously allocated at a 37.5 GHz spacing or 42.5 GHz spacing. A usage efficiency of a frequency is higher if carriers are allocated at a smaller spacing, which results in increasing a transmission capacity.

However, a crosstalk between wavelength channels increases if carriers are allocated at a smaller spacing. Thus, a superchannel is preferably designed in consideration of an impact of a crosstalk. However, a crosstalk does not uniformly affect each wavelength channel multiplexed in the superchannel.

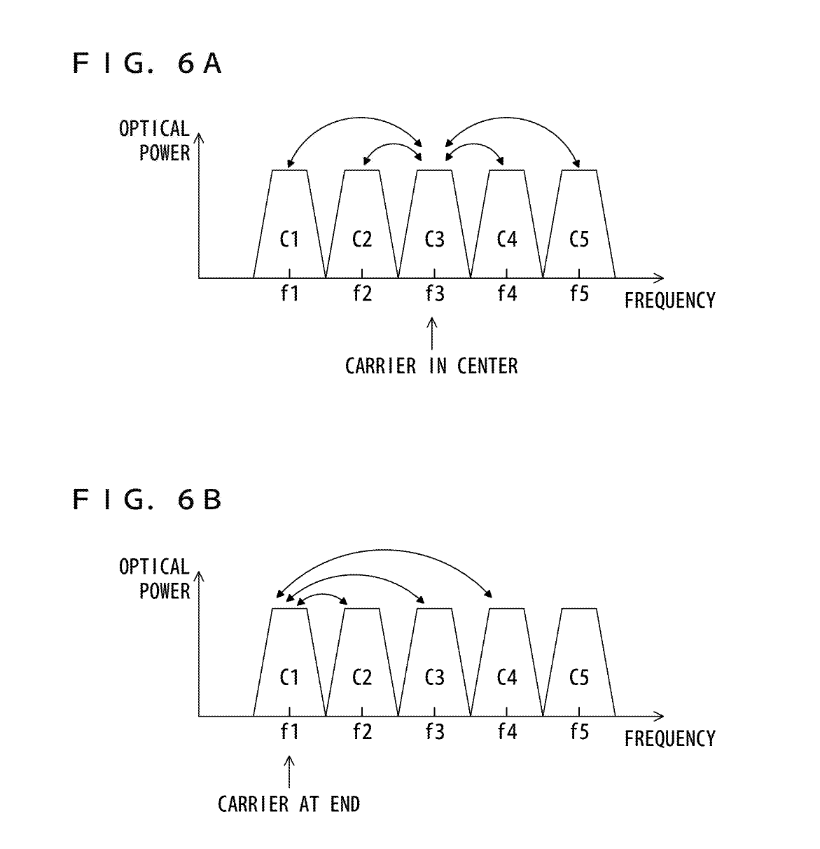

FIGS. 6A and 6B illustrate an interaction between a plurality of carriers multiplexed in a superchannel. In the examples illustrated in FIGS. 6A and 6B, a superchannel is implemented by five carriers C1-C5. Center frequencies of the carriers C1-C5 are f1-f5, respectively. Each carrier may implement one wavelength channel.

A carrier multiplexed in a superchannel (hereinafter referred to as an interested carrier) is affected by another carrier (hereinafter referred to as an aggressor carrier). Here, the carrier C3 is an interested carrier in FIG. 6A, and the carrier C1 is an interested carrier in FIG. 6B. That is to say, FIG. 6A schematically illustrates a state in which the carrier C3 allocated in the center of the superchannel is affected by the other carriers (C1, C2, C4, C5). FIG. 6B schematically illustrates a state in which the carrier C1 allocated at the end of the superchannel is affected by the other carriers (C2-C5). Note that the interested carrier is affected by the aggressor carriers more greatly if a difference between a frequency of the interested carrier and a frequency of the aggressor carrier is smaller. Thus, a degradation in quality due to a crosstalk is larger in the carrier C3 allocated in the center of the superchannel than in the other carriers. On the other hand, a degradation in quality due to a crosstalk is smaller in the carrier C1 or C5 allocated at the end of the superchannel than in the other carriers.

Thus, the WDM transmission device 1 according to the embodiments of the present invention has a function that controls optical powers of a plurality of carriers multiplexed in a superchannel such that the qualities of the respective carriers are substantially equalized when the superchannel signal is transmitted from the WDM transmission device 1. Here, if the optical powers of the respective carriers in the superchannel are the same, the quality of the carrier allocated in the center of the superchannel is likely to be lower than that of the carrier allocated at the end of the superchannel, as described above. Thus, the WDM transmission device 1 adjusts the powers of the respective carriers in the superchannel such that the optical power of the carrier allocated in the center is relatively higher than that of the carrier allocated at the end. In other words, the WDM transmission device 1 adjusts the powers of the respective carriers in the superchannel such that the optical power of the carrier allocated at the end is relatively lower than that of the carrier allocated in the center.

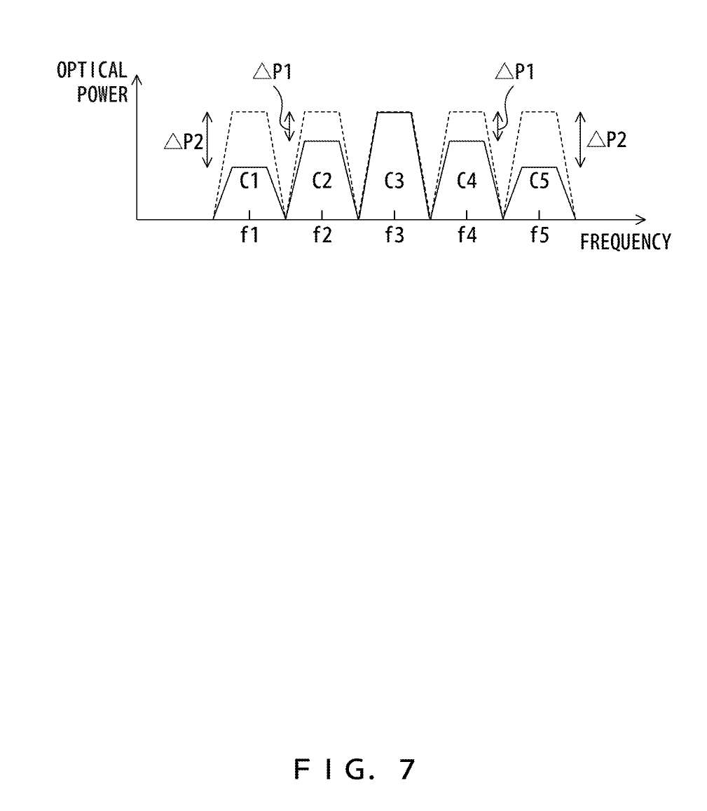

In the example illustrated in FIG. 7, the optical powers of the carriers C1-C5 multiplexed in a superchannel signal input into the WDM transmission device 1 are substantially the same each other. In FIG. 7, a spectrum of each carrier (that is, each carrier before optimization) that is input into the WDM transmission device 1 is indicated by a broken line. However, as described below, the optical power of the carrier C3 allocated in the center does not change with optimization, so the spectrum indicated by a broken line and the spectrum indicated by a solid line are the same with respect to the carrier C3.

Optimization of a superchannel signal is performed as follows. For example, the WDM transmission device 1 does not correct the optical power of the carrier C3 allocated in the center of a superchannel. As indicated by a solid line, the WDM transmission device 1 attenuates, by ΔP1, the optical powers of the carriers C2 and C4 that are adjacent to the carrier C3. Further, as indicated by a solid line, the WDM transmission device 1 attenuates, by ΔP2, the optical power of the carrier C1 and C5 that allocated at the end of the superchannel. ΔP2 is greater than ΔP1. As a result, a superchannel signal is implemented such that the optical powers of the carriers are smaller in order from the center to the end in a wavelength range of the superchannel signal. The difference between ΔP1 and ΔP2 may be the same as ΔP1, or it may be different from ΔP1.

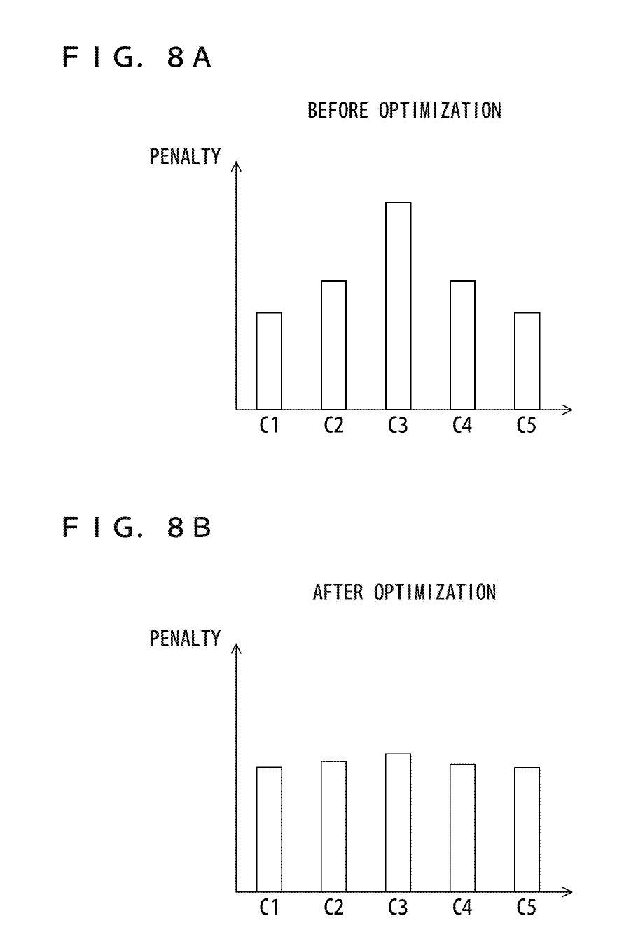

FIGS. 8A and 8B illustrate effects of optimization of a superchannel signal. FIG. 8A illustrates an OSNR (Optical Signal-to-Noise Ratio) penalty of each carrier when the optical powers of the carriers multiplexed in the superchannel are substantially the same each other. In this example, the quality of the carrier C3 allocated in the center of the superchannel is lower than that of the carrier C1 and C5 allocated at the end. Here, the transmission performance of the superchannel depends on the quality of a carrier whose quality is lowest. In other words, in this example, the transmission performance of the superchannel depends on the quality of the carrier C3.

FIG. 8B illustrates an OSNR penalty of each carrier after the optimization of FIG. 7 is performed. When the superchannel signal is optimized, the OSNR of the carrier C3 allocated in the center of the superchannel is improved, and thus the difference in the OSNR penalty becomes smaller between the carriers C1-C5. As a result, the transmission performance of the superchannel is improved. For example, a maximum transmission distance of a superchannel signal becomes longer.

### First Embodiment

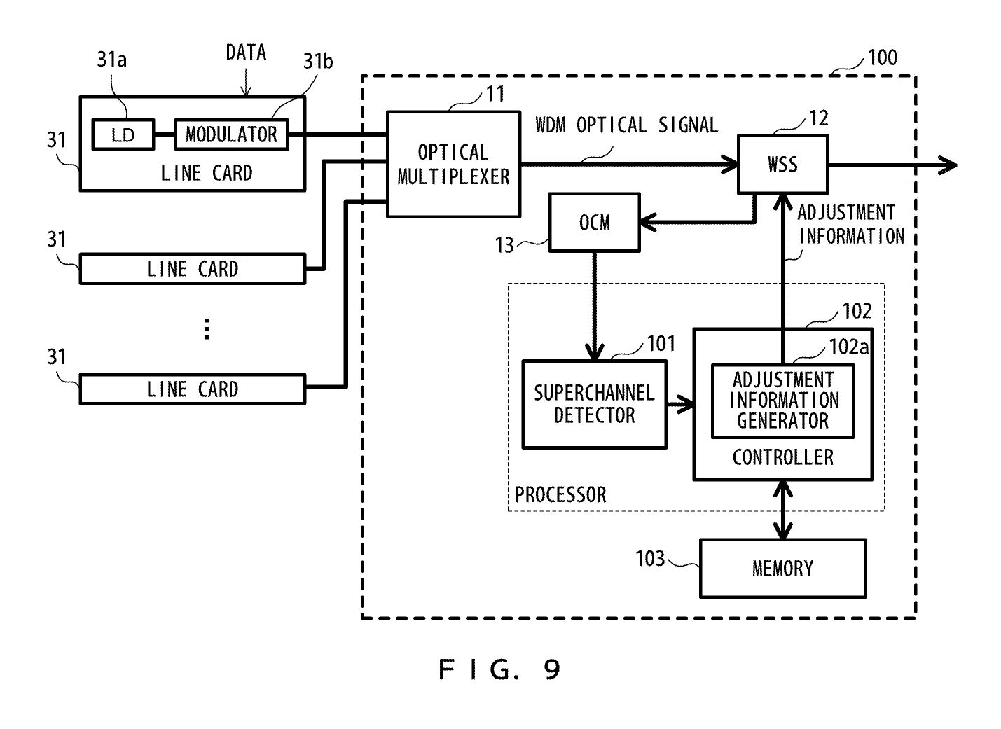

FIG. 9 illustrates an example of an optical transmission device according to a first embodiment. A WDM transmission device 100 is an example of the optical transmission device according to the first embodiment. FIG. 9 illustrates some of the functions provided by the WDM transmission device 100.

The WDM transmission device 100 is able to accommodate a plurality of line cards 31. Each line card 31 includes alight source 31a and an optical modulator 31b. The light source 31a generates a continuous wave light of a specified frequency or wavelength. The optical modulator 31b generates a modulated optical signal by demodulating the continuous light generated by the light source 31a with transmission data. The line card 31 generates an optical signal of a specified power. In other words, the line card 31 is configured such that an optical signal is output at an optical power within a range between a specified maximum value and a specified minimum value. The line card 31 may include a plurality of sets of the light source 31a and the optical modulator 31b.

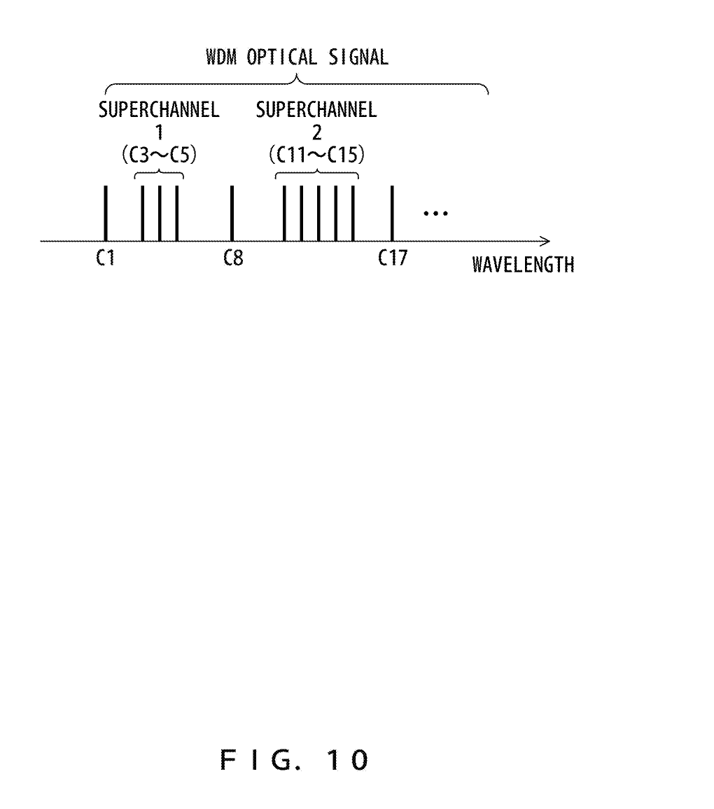

FIG. 10 illustrate an example of optical signals generated by a plurality of line cards 31. In the example illustrated in FIG. 10, optical signals are generated by use of carriers C1, C3-C5, C8, C11-C15 and C17, respectively. The carriers C3-C5 implement a superchannel 1. The carriers C11-C15 implement a superchannel 2. A superchannel is implemented by multiplexing a plurality of carriers (or a plurality of wavelength channels) continuously allocated at a frequency spacing not greater than 50 GHz. Thus, the superchannel signal is a WDM optical signal.

The WDM transmission device 100 includes an optical multiplexer 11, a wavelength selective switch (WSS) 12, an optical channel monitor (OCM) 13, a superchannel detector 101, a controller 102, and a memory 103. The optical multiplexer 11 combines optical signals output from a plurality of line cards 31 so as to generate a WDM optical signal. The wavelength selective switch 12 processes respective wavelength channels multiplexed in the WDM optical signal. The optical channel monitor 13 detects an optical power in a signal range of the WDM optical signal at a specified frequency spacing (or a specified wavelength). As a result, a spectrum of the WDM optical signal is obtained.

The superchannel detector 101 monitors a state of the WDM optical signal by use of an output signal of the optical channel monitor 13. The output signal of the optical channel monitor 13 indicates a spectrum of the WDM optical signal. Then, the superchannel detector 101 detects a superchannel signal included in the WDM optical signal according to the spectrum of the WDM optical signal. The superchannel signal is included in the WDM optical signal, as illustrated in FIG. 10. Further, the superchannel detector 101 is able to detect the number of carriers multiplexed in the superchannel signal. For example, in the example illustrated in FIG. 10, the superchannel detector 101 detects that the number of carriers in the superchannel signal 1 is three and that the number of carriers in the superchannel 2 is five.

The controller 102 controls operations of the WDM transmission device 100. For example, the controller 102 is able to process each optical signal multiplexed in a WDM optical signal by controlling the wavelength selective switch 12. Further, the controller 102 includes an adjustment information generator 102a.

The adjustment information generator 102a generates, according to the number of carriers multiplexed in a superchannel signal and their allocation, adjustment information used for adjusting an optical power of each of the carriers multiplexed in the superchannel signal. The adjustment information represents the wavelength characteristics in which an attenuation amount increases in order from the center to the end in a frequency range in which the superchannel signal is allocated. The adjustment information generator 102a may generate the adjustment information by referring to an optimization database stored in the memory 103.

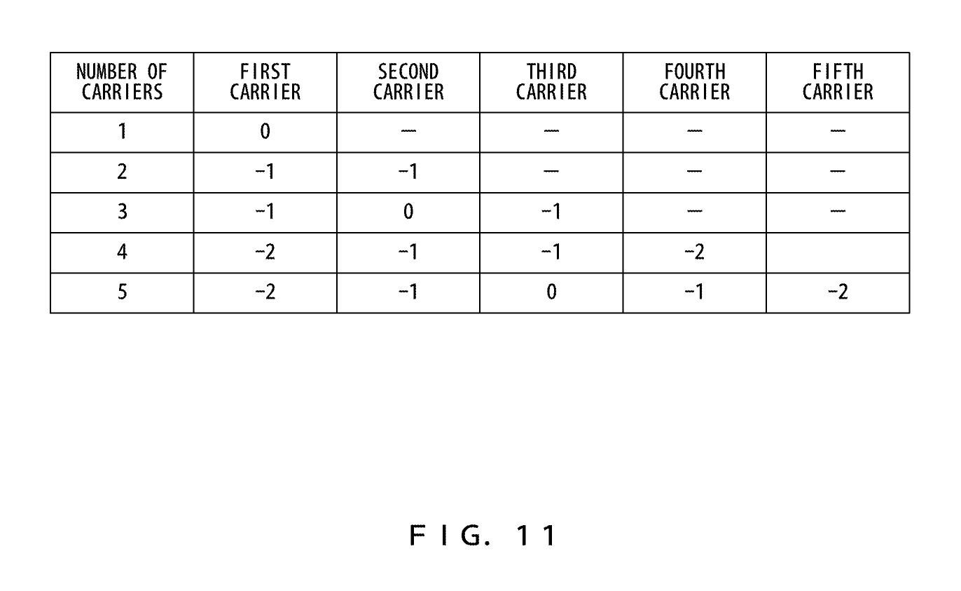

FIG. 11 illustrates an example of an optimization database. The optimization database stores therein correction values with respect to the number of carriers multiplexed in a superchannel signal. “FIRST CARRIER” to “FIFTH CARRIER” indicate positions of carriers in the superchannel signal. For example, “FIRST CARRIER” refers to a carrier of a lowest frequency among a plurality of carriers multiplexed in a superchannel signal. “SECOND CARRIER” refers to a carrier of a second lowest frequency among the plurality of carriers multiplexed in the superchannel signal. The correction value may indicate an attenuation amount of an optical power. For example, when three carriers are multiplexed in a superchannel signal, the correction values of the first carrier, the second carrier, and the third carrier are “−1”, “0”, and “−1”, respectively. The correction value is not particularly limited, but it is expressed in, for example, “dB”.

The adjustment information generator 102a refers to the optimization database so as to obtain correction values of respective carriers multiplexed in a superchannel signal. The adjustment information generator 102a generates adjustment information by use of the obtained correction values. This adjustment information is provided to the wavelength selective switch 12. Then, the wavelength selective switch 12 adjusts, according to the adjustment information, an optical power of each of the carriers multiplexed in the superchannel signal.

The superchannel detector 101 and the controller 102 may be implemented by a processor. In other words, the functions of the superchannel detector 101 and the controller 102 are provided by the processor executing a given program. However, some of the functions of the superchannel detector 101 and the controller 102 may be realized by a hardware circuit.

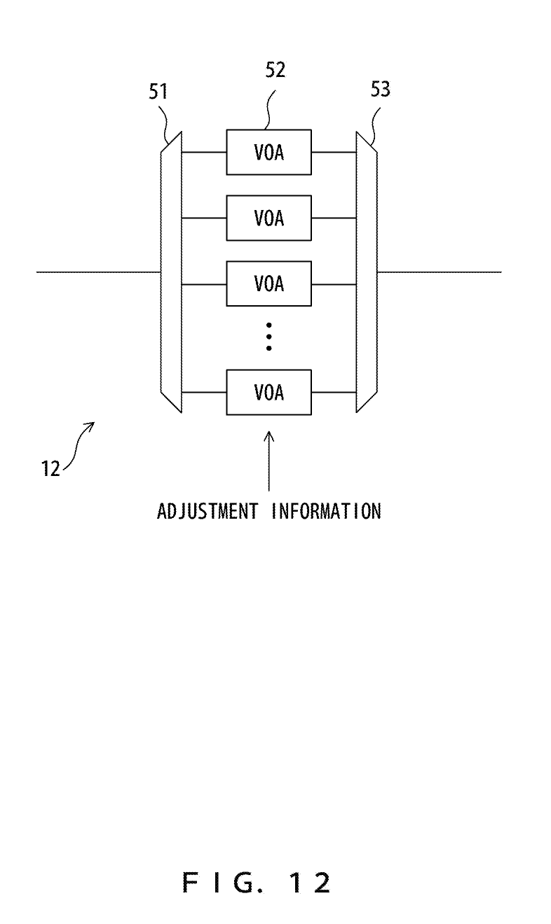

FIG. 12 schematically illustrates an attenuation function of the wavelength selective switch 12. The attenuation function of the wavelength selective switch 12 is represented by use of a demultiplexer 51, variable optical attenuators (VOA) 52, and a combiner 53. The attenuation (or the transmission) of a variable optical attenuator 52 is controlled by a given control signal. The control signal corresponds to the adjustment information generated by the controller 102. Further, a plurality of variable optical attenuators 52 are provided at a specified frequency spacing. For example, a power of the optical signal of a frequency f1 is adjusted if a variable optical attenuator 52 provided with respect to the frequency f1 is controlled, and a power of the optical signal of a frequency f2 is adjusted if a variable optical attenuator 52 provided with respect to the frequency f2 is controlled.

The attenuation function of the wavelength selective switch 12 may be implemented by LCOS (Liquid Crystal On Silicon) or MEMS (Micro Electro Mechanical Systems). The LCOS and the MEMS can adjust an optical power of a target frequency (or a target wavelength) with a desired attenuation amount. In the WDM transmission device 100, an attenuation function may be realized without using a wavelength selective switch. In this case, the attenuation function may be implemented by optical passive components such as an optical switch and a variable optical attenuator.

As an example, it is assumed that the superchannel signal 2 illustrated in FIG. 10 is detected by the superchannel detector 101. The superchannel signal 2 is implemented by five continuous carriers C11-C15. In other words, the number of carriers multiplexed in the superchannel signal 2 is five. In this case, the adjustment information generator 102a refers to the optimization database illustrated in FIG. 11 so as to obtain the correction values “−2, −1, 0, −1, −2”. Then, the adjustment information generator 102a generates adjustment information “C11:−2, C12:−1, C13:0, C14:−1, C15:−2” with respect to the superchannel signal 2 and provides the information to the wavelength selective switch 12.

The wavelength selective switch 12 adjusts, according to the adjustment information, the optical powers of the carriers multiplexed in the superchannel signal 2. Specifically, the wavelength selective switch 12 attenuates each of the optical powers of the carriers C11 and C15 by 2 dB, attenuates each of the optical powers of the carriers C12 and C14 by 1 dB, and maintains the optical power of the carrier C13. As a result, as illustrated in FIG. 7, a superchannel signal in which an optical power of a carrier allocated in the center is high and an optical power of a carrier allocated at the end is low is generated.

A correction value (that is, an attenuation amount for each carrier) is determined in advance according to, for example, the number of carriers multiplexed in a superchannel signal, a frequency spacing between the carriers, a signal transmission rate, a modulation scheme, and a total optical power of the superchannel signal. As an example, the quality (for example the error rate) of each wavelength channel is monitored at a destination node while the correction value is changed at a source node of a superchannel signal. During the monitoring, the correction value is determined such that the quality of each wavelength channel is optimized or such that the quality of each wavelength channel is higher than a specified threshold level. Note that the correction value may be determined based on a simulation.

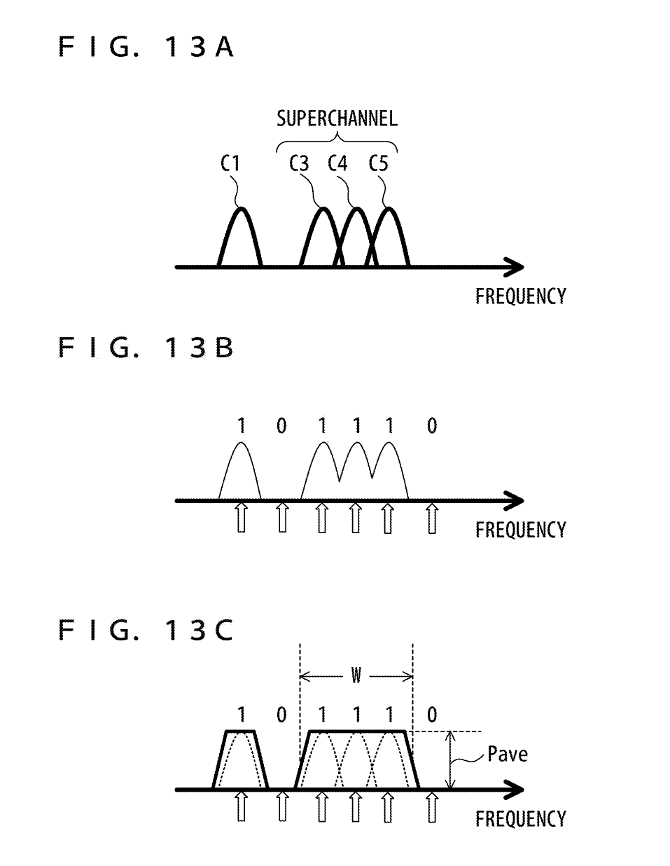

FIGS. 13A-13C are diagrams for explaining methods for detecting a superchannel signal by use of an output of an optical channel monitor. In this example, as illustrated in FIG. 13A, data is transmitted by use of a carrier C1 and carriers C3-C5. A carrier allocated between the carrier C1 and the carrier C3 does not transmit data. Further, the three continuous carriers C3-C5 are used for implementing a superchannel.

Each carrier is allocated on a frequency grid configured at a specified frequency spacing. The spacing of the frequency grid is not particularly limited, but it is not greater than 50 GHz. Thus, when data is transmitted by use of a plurality of continuous carriers, a spectrum may have an overlapping portion between adjacent carriers. In the example illustrated FIG. 13A, the spectrum may have an overlapping portion between the carriers C3 and C4, and the spectrum may have an overlapping portion between the carriers C4 and C5.

FIG. 13B illustrates a spectrum detected by a high-resolution optical channel monitor. Even when data is transmitted by use of a plurality of continuous carriers, the peak of the spectrum appears at the center frequency of each of the carriers if an optical channel monitor has high resolution. In other words, the peak appears at the center frequency of each of the carriers C3, C4, and C5.

In this case, first, the superchannel detector 101 detects a frequency range in which an optical power is higher than a specified threshold level. Then, when the width of the frequency range is wider than a specified frequency width, the superchannel detector 101 decides that a superchannel signal is allocated in the frequency range. In the example illustrated in FIG. 13B, a superchannel signal is detected in the frequency range in which the carriers C3-C5 are allocated. Further, the superchannel detector 101 counts the number of peaks of the spectrum in the frequency range in which the superchannel signal is allocated. In this example, there exist three peaks. Thus, the superchannel detector 101 decides that the number of carriers multiplexed in the superchannel signal is three.

FIG. 13C illustrates a spectrum detected by a low-resolution optical channel monitor. When data is transmitted by use of a plurality of continuous carriers, there is a possibility that a peak of the spectrum corresponding to each of the carriers will not appear if an optical channel monitor has low resolution. In this case, the superchannel detector 101 detects the number of carriers multiplexed in a superchannel signal by Method A or Method B described below. The method for detecting a superchannel signal from a generated spectrum by use of an optical channel monitor has already been described above.

In Method A, the number of carriers multiplexed in a superchannel signal is calculated by dividing a total optical power of the superchannel signal by an optical power per carrier. In this case, the line card 31 generates an optical signal at a power specified in advance. In other words, the line card 31 outputs an optical signal at a power within a range between a specified maximum value Pmax and a specified minimum value Pmin. It is assumed that there does not exist any attenuation factor between the line card 31 and the optical channel monitor 13. Then, an optical power per carrier Pc can be approximately represented as (Pmax+Pmin)/2. Further, as illustrated in FIG. 13C, when the width of a frequency range in which an optical power is higher than a specified threshold level is W and when an average optical level of a superchannel signal is Pave, a total optical power of the superchannel signal is represented as Pave×W (a product of an average optical power and a width of the superchannel). In this case, the number of carriers multiplexed in the superchannel signal is calculated by dividing Pave×W by Pc.

In Method B, it is assumed that a frequency spacing of a frequency grid on which a carrier is allocated is known. In this case, the number of carriers multiplexed in a superchannel signal is calculated by dividing, by the frequency spacing of the frequency grid, the width W of a frequency range in which an optical power is higher than a specified threshold level.

The spectrum at the end of a superchannel signal may widen according to an optical-signal modulating scheme and an optical-signal transmission rate. Thus, when detecting the width W of a frequency range in which an optical power is higher than a specified threshold level, it is necessary to determine the threshold level appropriately. As an example, a value that is less than a maximum value of an optical power of a superchannel signal by 3 dB may be a threshold. Note that Method A and Method B described above may be used not only when an optical channel monitor has low resolution but also when an optical channel monitor has high resolution.

The arrows illustrated in FIGS. 13B and 13C represent sampling points that determine whether an optical power is higher than a specified threshold level. Further, a decision result at each sampling point is represented by “1: Higher than threshold level” or “0: Lower than threshold level”.

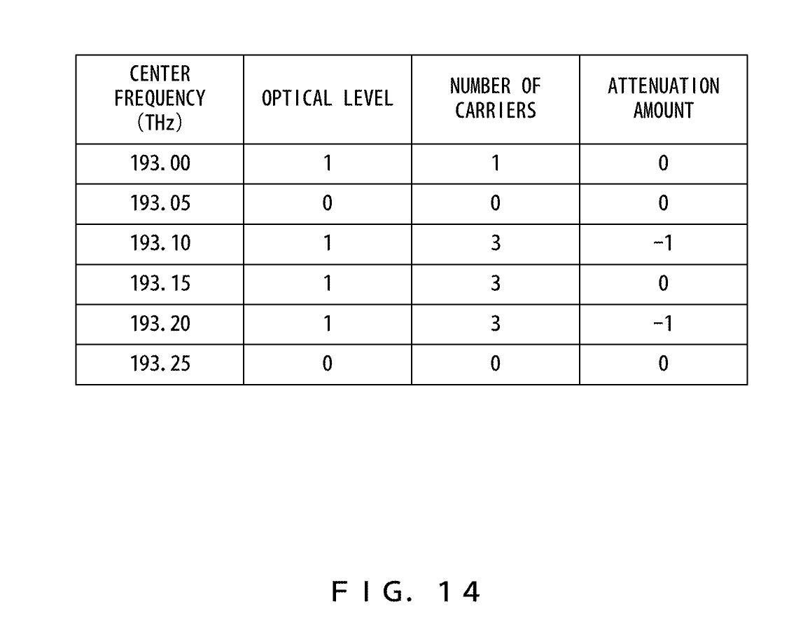

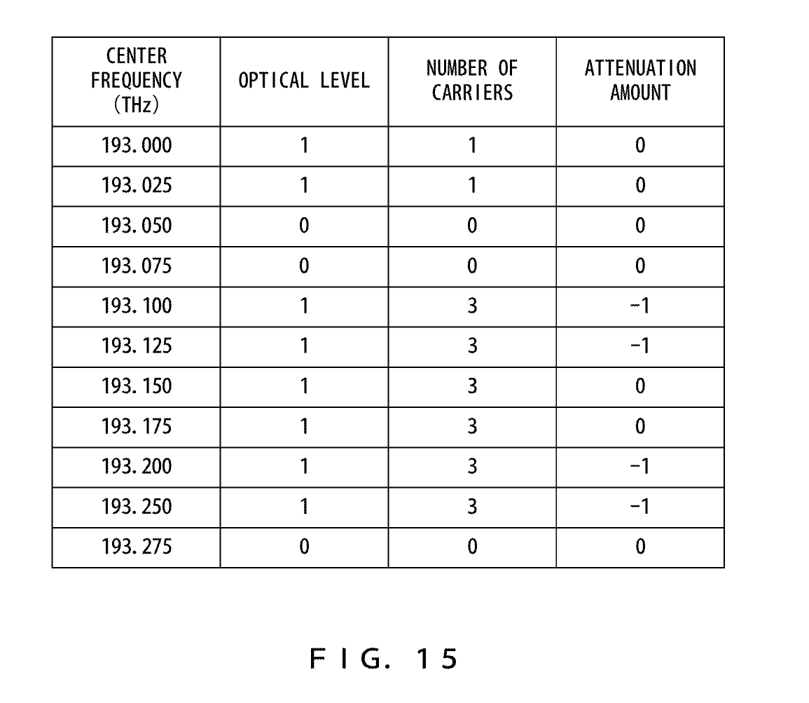

FIGS. 14 and 15 illustrate examples of management tables that manage optimization of a superchannel signal. The management table is stored in the memory 103 of FIG. 9 and updated by the controller 102.

The management table of FIG. 14 is used in, for example, a WDM system in which a carrier is allocated on a fixed grid of a 50 GHz spacing. In this example, it is assumed that the attenuation function of the wavelength selective switch 12 adjusts a power of an input light at a 50 GHz spacing.

The superchannel detector 101 samples an output signal of the optical channel monitor 13 at a 50 GHz spacing. In other words, a spectrum of an input optical signal of the WDM transmission device 100 is sampled at a 50 GHz spacing. Then, the superchannel detector 101 decides whether an optical power at each sampling point is higher than a specified threshold level, and writes a decision result into the management table. In the example illustrated in FIG. 14, it is decided that each of the optical powers at 193.00 THz, 193.10 THz, 193.15 THz, and 193.20 THz is higher than the threshold level, and it is decided that each of the optical powers at 193.05 THz and 193.25 THz is lower than the threshold level. In addition, the superchannel detector 101 detects a superchannel signal according to a frequency range in which an optical power is higher than the threshold level. In the example illustrated in FIG. 14, it is decided that a superchannel signal is allocated in a range of a frequency between 193.10 Thz and 193.20 THz and its vicinity. Further, the superchannel detector 101 detects the number of carriers multiplexed in the superchannel signal. In the example illustrated in FIG. 14, the number of carriers is three. The number of carriers multiplexed in a superchannel signal is, for example, detected by any one of the methods described with reference to FIGS. 13A-13C.

An attenuation amount of a carrier frequency is determined by referring to the optimization database illustrated in FIG. 11. In the example illustrated in FIG. 14, a superchannel signal is allocated in a range of a frequency between 193.10 THz and 19.20 THz and its vicinity. Thus, “−1 dB”, “0”, and “−1 dB” are allocated to 193.10 THz, 193.15 THz, and 193.20 THz, respectively. Next, the adjustment information generator 102a generates adjustment information that indicates this allocation and provides the adjustment information to the wavelength selective switch 12. By doing this, the wavelength selective switch 12 attenuates, by 1 dB, the light of 193.10±0.025 THz and the light of 193.20±0.025 THz.

As a result, a superchannel signal in which an optical power of a carrier allocated in the center is high and an optical power of a carrier allocated at the end is low is generated. Thus, a degradation in an OSNR of a particular carrier (that is, a carrier allocated in the center) due to a crosstalk between carriers multiplexed in the superchannel signal is suppressed.

The management table illustrated in FIG. 15 is used in a WDM transmission system in which a carrier is allocated on a flexible grid. In this example, a wavelength channel is arranged by use of a grid that is set up at a 25 GHz spacing. It is assumed that the attenuation function of the wavelength selective switch 12 adjusts a power of an input light at a 25 GHz spacing.

The method for detecting a superchannel signal from an input optical signal, the method for detecting the number of carriers, and the method for allocating an attenuation amount to a frequency range in which a superchannel signal is allocated are substantially the same in the examples illustrated in FIGS. 14 and 15. Thus, “−1 dB” is allocated to 193.100 THz and 193.125 THz, “0” is allocated to 193.150 THz and 193.175 THz, and “−1 dB” is allocated to 193.200 THz and 193.225 THz. The adjustment information generator 102a generates adjustment information that indicates this allocation and provides the information to the wavelength selective switch 12. Then, the wavelength selective switch 12 attenuates an optical power of an input light according to the adjustment information.

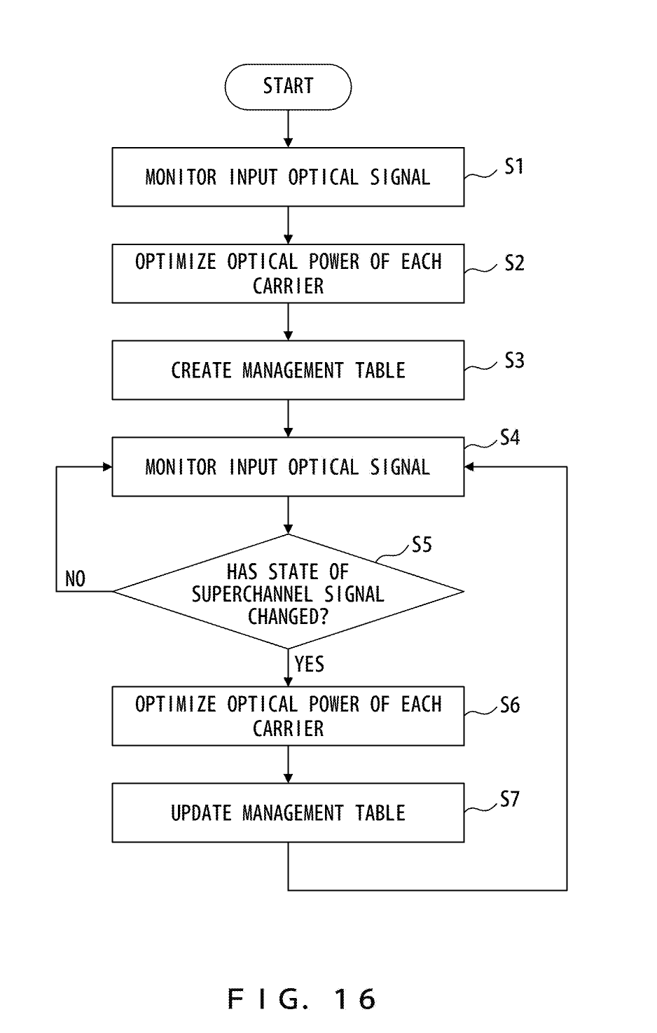

FIG. 16 is a flowchart that illustrates an example of processing of optimizing a superchannel signal. The processing in the flowchart is performed, for example, when the WDM transmission device 100 starts operating.

In S1, the optical channel monitor 13 monitors a power of an input optical signal and detects its spectrum. In other words, an output signal of the optical channel monitor 13 indicates the spectrum of the input optical signal. Then, the superchannel detector 101 detects a wavelength division multiplexed optical signal (that is, a superchannel signal) that includes a plurality of carriers continuously allocated at a specified frequency spacing by use of the output signal of the optical channel monitor 13. When a superchannel signal is detected, the superchannel detector 101 detects the number of carriers multiplexed in the superchannel signal.

In S2, the controller 102 adjusts an optical power of each carrier according to a detection result obtained in S1. In other words, the controller 102 adjusts an optical power of each carrier multiplexed in the superchannel signal. At this point, the adjustment information generator 102a refers to an optimization database so as to obtain a correction value (that is, an attenuation amount) with respect to each carrier according to the number of carriers multiplexed in the superchannel signal. Then, the adjustment information generator 102a generates adjustment information that includes the obtained correction value and provides the adjustment information to the wavelength selective switch 12. As a result, the optical power of each carrier multiplexed in the superchannel signal is optimized. When a superchannel signal is not detected in S1, the process of S2 may be skipped.

In S3, the controller 102 creates a management table and writes the detection result obtained in S1 into the management table. As illustrated in FIG. 14 or 15, the management table manages whether a power of an input optical signal is higher than a threshold level at a specified frequency spacing. Further, the management table also manages the number of carriers in a detected superchannel signal. When the initial settings performed in S1-S3 are terminated, the process of the WDM transmission device 100 moves on to S4.

The processes of S4-S7 are repeatedly performed while the WDM transmission device 100 is operating. The process of S4 is substantially the same as that of S1. In other words, the optical channel monitor 13 monitors a power of an input optical signal and detects its spectrum. The superchannel detector 101 detects a superchannel signal by use of the output signal of the optical channel monitor 13. When a superchannel signal is detected, the superchannel detector 101 detects the number of carriers multiplexed in the superchannel signal.

In S5, the controller 102 decides whether the state of the superchannel has changed. Here, the controller 102 compares a superchannel signal newly detected in S4 with a superchannel signal detected earlier and already recorded in the management table. Specifically, the controller 102 compares the frequency range in which the newly detected superchannel signal is allocated with the frequency range in which the superchannel signal recorded in the management table is allocated. In this case, the widths of the frequency ranges may be compared, or the positions of the frequency ranges (for example, the center frequencies) may be compared. Further, the controller 102 compares the number of carriers of the newly detected superchannel signal with the number of carriers of the superchannel signal recorded in the management table. In any case, when the newly detected superchannel signal is the same as the superchannel signal recorded in the management table, it is decided that the state of the superchannel signal has not changed, and when the newly detected superchannel signal is different from the superchannel signal recorded in the management table, it is decided that the state of the superchannel signal has changed. When a new superchannel signal is generated, it is determined to be “YES” in S5.

When the state of the superchannel signal has not changed, the controller 102 decides that the superchannel signal has already been optimized. In this case, the process of the controller 102 returns to S4. On the other hand, when the state of the superchannel signal has changed, the process of the controller 102 moves on to S6.

The process of S6 is substantially the same as that of S2. Specifically, the controller 102 adjusts an optical power of each carrier in the newly detected superchannel signal according to a detection result obtained in S4. In other words, the adjustment information generator 102a obtains a correction value (that is, an attenuation amount) with respect to each carrier according to the number of carriers multiplexed in the superchannel signal. Then, the adjustment information generator 102a generates adjustment information that includes the obtained correction value and provides the adjustment information to the wavelength selective switch 12. As a result, the optical power of each carrier multiplexed in the superchannel signal is optimized.

In S7, the controller 102 updates the management table according to the detection result obtained in S4. In other words, information that indicates the state of a latest input WDM optical signal is recorded in the management table. After that, the process of the WDM transmission device 100 returns to S4.

As described above, the optical transmission device of the first embodiment monitors an input WDM optical signal and optimizes a superchannel signal according to a result of the monitoring. Thus, the optical transmission device is able to optimize a superchannel signal without receiving a control signal that indicates, for example, settings, an addition, or a deletion of the superchannel signal. In other words, the optical transmission device is able to suppress a crosstalk between carriers of a WDM optical signal without an instruction or a control from the outside. Further, the optical transmission device is able to optimize a superchannel signal without depending on a line card accommodated in the optical transmission device.

In the example described above, an optical power of each carrier is adjusted according to the number of carriers multiplexed in a superchannel signal, but the embodiments of the present invention are not limited to this configuration. For example, when a superchannel signal is detected, the controller 102 may control the wavelength selective switch 12 such that an attenuation amount increases gradually from the center to the end of the frequency range in which the superchannel signal is allocated. In this case, there is no need to count the number of carriers multiplexed in the superchannel signal, which results in providing an easy configuration for optimizing a superchannel signal.

In the example described above, the WDM transmission device 100 processes an optical signal output from the line card 31 connected to the WDM transmission device 100, but the embodiments of the present invention are not limited to this configuration. In other words, the WDM transmission device 100 may monitor a WDM optical signal received through a transmission path fiber, so as to adjust an optical power of each carrier of a superchannel signal detected from the WDM optical signal. However, in this case, the WDM transmission device 100 adjusts an output power of each carrier of the superchannel signal such that an optical power of a carrier allocated at the end is lower than that of a carrier allocated in the center in the frequency range of the superchannel signal.

In the example described above, a superchannel signal is optimized, but the embodiments of the present invention are not limited to this configuration. In other words, the WDM transmission device 100 is able to optimize a wavelength division multiplexed optical signal that includes a plurality of carriers continuously allocated at a specified frequency spacing.

### Second Embodiment

In the first embodiment, as described with reference to FIG. 7, a superchannel signal is optimized by adjusting an optical power of each carrier multiplexed in the superchannel signal. On the other hand, in a second embodiment, a carrier frequency of an optical signal generated in a line card is adjusted.

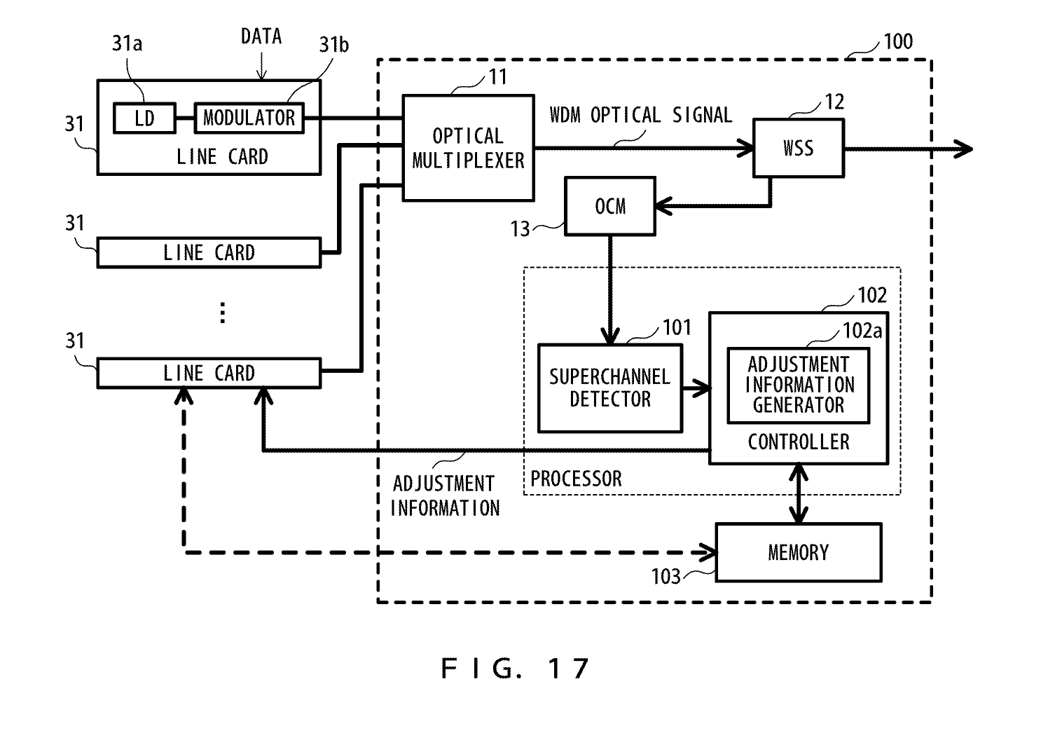

FIG. 17 illustrates an example of an optical transmission device according to the second embodiment. Also in the second embodiment, a WDM transmission device is an example of an optical transmission device. Further, the method for detecting a superchannel signal from an input optical signal and the method for counting the number of carriers multiplexed in the superchannel signal are substantially the same in the first and second embodiments.

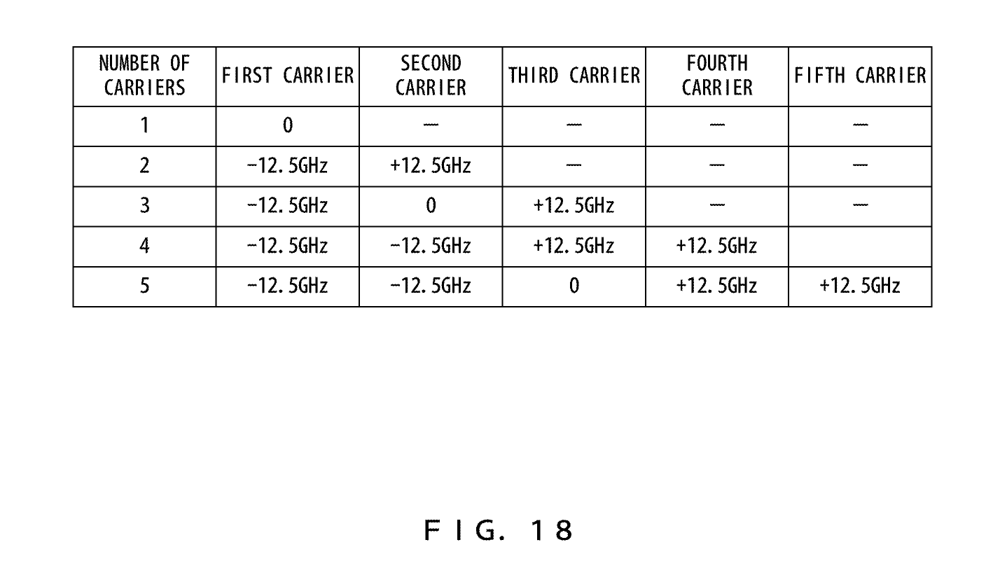

FIG. 18 illustrates an example of an optimization database used in the second embodiment. In the second embodiment, a frequency shift amount is specified as a correction value with respect to each carrier. For example, when three carriers are multiplexed in a superchannel signal, the correction values with respect to the first carrier, the second carrier, and the third carrier are “−12.5 GHz”, “0”, and “+12.5 GHz”, respectively. The correction value may be expressed in wavelength.

The adjustment information generator 102a refers to the optimization database so as to obtain a correction value of each carrier multiplexed in a superchannel signal. The adjustment information generator 102a generates adjustment information by use of the obtained correction value. This adjustment information is provided to corresponding line cards 31. Then, each of the line cards 31 adjusts, according to the adjustment information, the oscillation frequency of the light source 31a.

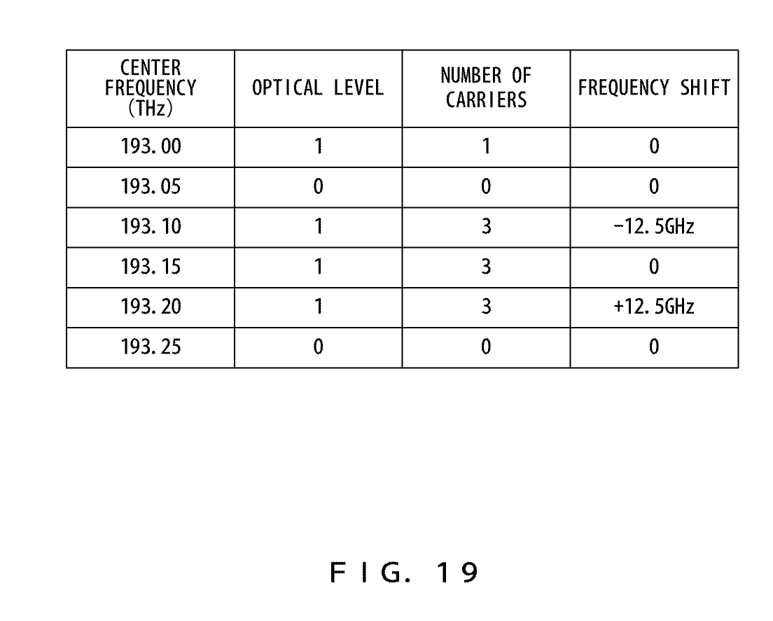

FIG. 19 illustrates an example of a management table used in the second embodiment. In the first embodiment, as illustrated in FIGS. 14 and 15, an attenuation amount is recorded as a correction value, but in the second embodiment, a frequency shift amount is recorded as a correction value. In the example described above, adjustment information is provided by the adjustment information generator 102a to a corresponding line card 31, but the embodiments of the present invention are not limited to this configuration. For example, each line card 31 may refer to the management table stored in the memory 103, so as to adjust its own oscillation frequency.

As described above, according to the embodiments of the present invention, an optical transmission device that is able to suppress a crosstalk between wavelength channels of a WDM optical signal is implemented without an instruction or a control from the outside.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission device comprising:
a monitor configured to monitor a power of an input optical signal and detect a spectrum of the input optical signal;
a detector configured to detect a wavelength division multiplexed optical signal that includes a plurality of carriers continuously allocated at a specified frequency spacing based on the spectrum of the input optical signal;
a generator configured to generate adjustment information that specifies an attenuation amount in a frequency range in which the wavelength division multiplexed optical signal is allocated; and
a power adjustment device configured to adjust powers of respective carriers multiplexed in the wavelength division multiplexed optical signal according to the adjustment information generated by the generator.

2. The optical transmission device according to claim 1, wherein
the adjustment information specifies the wavelength characteristics in which an attenuation amount increases from the center to the end in the frequency range in which the wavelength division multiplexed optical signal is allocated.

3. The optical transmission device according to claim 1, wherein
the detector further detects the number of carriers multiplexed in the wavelength division multiplexed optical signal, and
the generator generates the adjustment information according to the number of carriers detected by the detector.

4. The optical transmission device according to claim 3, wherein
the detector detects the number of carriers multiplexed in the wavelength division multiplexed optical signal according to the number of peaks of the spectrum in the frequency range in which the wavelength division multiplexed optical signal is allocated.

5. The optical transmission device according to claim 3, wherein
when an input optical power of each carrier multiplexed in the wavelength division multiplexed optical signal is controlled between a first value and a second value, the detector detects the number of carriers multiplexed in the wavelength division multiplexed optical signal by dividing, by an average of the first value and the second value, a total optical power of the wavelength division multiplexed optical signal calculated according to the spectrum.

6. The optical transmission device according to claim 3, wherein
the detector detects the number of carriers multiplexed in the wavelength division multiplexed optical signal by dividing a width of a spectrum of the wavelength division multiplexed optical signal by a frequency spacing of the carriers multiplexed in the wavelength division multiplexed optical signal.

7. The optical transmission device according to claim 1, wherein
when the state of the wavelength division multiplexed optical signal detected by the detector is changed, the generator generates new adjustment information and provides the new adjustment information to the power adjustment device.

8. The optical transmission device according to claim 1, wherein
the detector detects a width or a position of the frequency range in which the wavelength division multiplexed optical signal is allocated, and
the generator generates new adjustment information and provides the new adjustment information to the power adjustment device when the width or the position of the frequency range in which the wavelength division multiplexed optical signal is allocated is changed.

9. The optical transmission device according to claim 8, wherein
the detector samples the spectrum of the input optical signal at a specified frequency spacing so as to decide whether an optical power is higher than a specified threshold level with respect to each sampling point, and detects, according to a result of the decision performed at each of the sampling points, the width or the position of the frequency range in which the wavelength division multiplexed optical signal is allocated.

10. The optical transmission device according to claim 3, wherein
the generator generates new adjustment information and provides the new adjustment information to the power adjustment device when the number of carriers multiplexed in the wavelength division multiplexed optical signal detected by the detector is changed.

11. An optical transmission device comprising:
a signal source circuit configured to generate an optical signal including a plurality of carriers;
a monitor configured to monitor a power of the optical signal and detect a spectrum of the optical signal;
a detector configured to detect a wavelength division multiplexed optical signal that includes a plurality of carriers continuously allocated at a specified frequency spacing based on the spectrum of the optical signal; and
a generator configured to generate an instruction to widen a frequency spacing of carriers allocated in a central area of a frequency range in which the wavelength division multiplexed optical signal is allocated, wherein
the signal source circuit adjusts frequencies of respective carriers multiplexed in the wavelength division multiplexed optical signal according to the instruction.
